(19) United States
(12) Patent Application Publication
(10) Pub. No.: US 2003/0041777 A1
(43) Pub. Date: Mar. 6, 2003

(54) Inkjet ink

(76) Inventors: Alfons Karl, Grundau (DE); Gerd Tauber, Seligenstadt (DE); Werner Kalbitz, Rodenbach (DE); Horst Kleinhenz, Grosskrotzenburg (DE); Ralph McIntosh, Hanau (DE); Stephan Ludtke, Biebergemund (DE)

Correspondence Address: SMITH, GAMBRELL & RUSSELL, LLP, 1850 M STREET, N.W., SUITE 800, WASHINGTON, DC, 20036, US

(21) Appl. No.: 10/116,130

(22) Filed: Apr. 5, 2002

(30) Foreign Application Priority Data
Apr. 7, 2001 (DE) 101 17 504.3

(51) Int. Cl. C09D 11/00

(52) U.S. Cl. 106/31.65; 106/31.9

(57) ABSTRACT

The inkjet ink contains at least one pigment and at least one compound having a mean particle size of greater than 50 nm from the group comprising pyrogenic silicic acid, hydrophobised pyrogenic silicic acid, pyrogenic mixed oxides or pyrogenic aluminium oxides.

The inks are prepared by mixing at least one pigment dispersed in water and a compound having a mean particle size of greater than 50 nm from the group comprising pyrogenic silicic acid, hydrophobised pyrogenic silicic acid, pyrogenic mixed oxides or pyrogenic aluminium oxides.

The inks may be used to print paper or sheets with an inkjet printer.

The present invention relates to an inkjet ink, a process for its production and its use.

The inkjet printing process is a known duplicating technique in which the printing ink is transferred in a pressureless manner, i.e. without contact between the print head and the print medium. In this connection ink droplets are sprayed from a nozzle onto a receiving material, the deflection of the droplets being able to be controlled electronically. This technique, which is also termed pressureless printing, is particularly suitable for the printing of products having irregular surfaces and packagings since there is a certain interspacing between the print head and the printed material. The printing process is extremely flexible and relatively inexpensive and is therefore also used in computer printing, for example as a workplace printer. The inkjet process is increasingly used in the industrial sector, for example in outdoor advertising and publicity. In outdoor advertising and publicity the ink must satisfy special requirements as regards lightfastness and water stability. Dyes as well as pigments are used as chromophoric substances. Pigments have the advantage over dyes in that their lightfastness is extremely high.

Inkjet recording processes are known in which a reaction solution and an ink are applied to a recording material and the ink contains a chromophoric substance, an inorganic colloidal oxide and an aqueous solvent and has a pH value of not less than 9 (U.S. Pat. No. 6,039,796).

Furthermore inks are known that consist mainly of water, a water-miscible organic liquid, a dye in a concentration of at least 0.5 wt. %, optionally a wetting agent, optionally a biocide, optionally a pH regulator and silicic acid particles in a concentration of 0.1 to 5 wt. %, (U.S. Pat. No. 5,221,332).

Moreover pigmented inkjet inks are known with an aqueous carrier material, a pigment and aluminium-stabilised colloidal silicic acid particles having a mean particle size of 0.005 μm to 0.050 μm (U.S. Pat. No. 5,925,178).

A disadvantage of the known inkjet inks is the low optical density and water resistance.

The object therefore exists of providing inkjet inks having a higher optical density and water resistance.

The present invention provides an inkjet ink which is characterised in that it contains at least one pigment and at least one compound with a mean particle size of greater than 50 nm, preferably greater than 60 nm, from the group comprising pyrogenic silicic acid, hydrophobised pyrogenic silicic acid, pyrogenic mixed oxides or pyrogenic aluminium oxides.

As pigment there may be used pigment blacks. As pigment blacks there may be used furnace black, gas black, channel black or lamp black. Examples of these are colour black FW 200, colour black FW 2, colour black FW 2 V, colour black FW 1, colour black FW 18, colour black S 170, colour black S 160, special black 6, special black 5, special black 4, special black 4A, Printex 150 T, Printex U, Printex V, Printex 140 U, Printex 140 V, Printex 95, Printex 90, Printex 85, Printex 80, Printex 75, Printex 55, Printex 45, Printex 40, Printex P, Printex 60, Printex XE 2, Printex L 6, Printex L, Printex 300, Printex 30, Printex 3, Printex 35, Printex 25, Printex 200, Printex A, Printex G, special black 550, special black 350, special black 250, special black 100, lamp black 101 from Degussa AG. In a preferred embodiment of the invention gas blacks may be used.

As pigments there may be used silicon-containing carbon blacks, known from DE 196 13 796, WO 96/37447 and WO 96/37547, or metal-containing carbon blacks, known from WO 98/42778.

As pigment there may be used color pigments. As color pigments there may be used blue pigments, such as, Sunfast blue, from Sun Chemical Company, red pigments, such as, Indofast Brilliant Scarlet, from Bayer Company, Sunfast megenta from Sun Chemical Company, green pigments, such as, Heliogen green from BASF Corporation, yellow pigments, such as, Sunbrite yellow from Sun Chemical, yellow 131AK from Ciba Chemicals Corporation.

As pyrogenic silicic acid there may be used Aerosil 90, Aerosil 200, Aerosil OX 50 or Aerosil 300, as hydrophobised pyrogenic silicic acid there may be used Aerosil R 8200, Aerosil R 202 or Aerosil R 972, as pyrogenic mixed oxides there may be used Aerosil MOX 80 or Aerosil MOX 170 and as pyrogenic aluminium oxide there may be used aluminium oxide C from Degussa AG.

The pH value of the inkjet ink may be less than 9, preferably less than 8.5.

The pigment content in the inkjet ink may be 1 to 20 wt. %, preferably 3-7 wt. %. The content of the compound from the group comprising pyrogenic silicic acid, hydrophobised pyrogenic silicic acid, pyrogenic mixed oxides or pyrogenic aluminium oxides may be 0.2 to 10 wt. %, preferably 0.5 to 5 wt. %.

The inkjet ink may in addition contain biocides, antifoaming agents or wetting agents.

The present invention also provides a process for the production of inkjet inks, which is characterised in that at least one pigment is dispersed in water, optionally with the addition of wetting agents, and the pigment dispersion is mixed with a compound having a mean particle size of greater than 50 nm, preferably greater than 60 nm, from the group comprising pyrogenic silicic acid, hydrophobised pyrogenic silicic acid, pyrogenic mixed oxides or pyrogenic aluminium oxides.

The pigment may be dispersed for example using bead mills, ultrasound devices or in an Ultra-Turrax machine. The mixing of the compound from the group comprising pyrogenic silicic acid, hydrophobised pyrogenic silicic acid, mixed oxides or pyrogenic aluminium oxides with the pigment dispersion may be carried out while stirring.

The inkjet ink according to the invention may be used for printing paper or sheets with an inkjet printer.

The inkjet ink according to the invention has a high optical density and water resistance.

### Examples 1-6

The inkjet inks are prepared as follows:

A 5% standard formulation is used as ink formulation. The carbon black dispersion consists of 15 wt. % colour black FW 18, 10 wt. % Hydropalat 3065, 0.2 wt. % AMP 90 and 74.8% water.

Hydropalat 3065 is a non-ionic wetting agent (manufacturer: Cognis). AMP 90 is an amine (manufacturer: Angus Chemie).

Triethylene glycol and water are premixed with the aid of a magnetic stirring rod and the carbon black dispersion is added while stirring. The compound from the group comprising pyrogenic silicic acid, hydrophobised pyrogenic silicic acid, pyrogenic mixed oxides or pyrogenic aluminium oxides is then added dropwise by means of a pipette while stirring. The aqueous dispersions are dispersions based on pyrogenic silicic acid, hydrophobised pyrogenic silicic acid, pyrogenic mixed oxides or pyrogenic aluminium oxides, or are colloidal aqueous solutions of silicic acid (=silica sols). The formulation is shown in Table 1. The specified parts by weight of the compounds from the group comprising pyrogenic silicic acid, hydrophobised pyrogenic silicic acid, pyrogenic mixed oxides or pyrogenic aluminium oxides refer to the concentration given in brackets (Example 1: 4.00 wt. % of a 25% solution is equivalent to 1 wt. %).

TABLE 1

| | Mean | | | | | | | | | | | | | | | |
|---|---|---|---|---|---|---|---|---|---|---|---|---|---|---|---|---|
| | Particle | | | | | | | | | | | | | | | |
| Formulation | Size | Comparison Example | | | | | | | | | Example | | | | | |
| (wt. %) | (nm) | 1 | 2 | 3 | 4 | 5 | 6 | 7 | 8 | 9 | 1 | 2 | 3 | 4 | 5 | 6 |
| Carbon black | | 33.0 | 33.0 | 33.0 | 33.0 | 33.0 | 33.0 | 33.0 | 33.0 | 33.0 | 33.0 | 33.0 | 33.0 | 33.0 | 33.0 | 33.0 |
| dispersion | | | | | | | | | | | | | | | | |
| Triethylene | | 15 | 15 | 15 | 15 | 15 | 15 | 15 | 15 | 15 | 15 | 15 | 15 | 15 | 15 | 15 |
| glycol | | | | | | | | | | | | | | | | |
| Distilled water | | 52.00 | 50.00 | 48.00 | 48.67 | 45.33 | 49.50 | 47.00 | 48.00 | 44.0 | 48.00 | 44.0 | 45.33 | 38.67 | 47.79 | 43.58 |
| Köstrosol 3550 | 50 | | 2.00 | 4.00 | | | | | | | | | | | | |
| (50%) | | | | | | | | | | | | | | | | |
| K\ddot{os}trosol 0830 | 8 | | | | 3.33 | 6.67 | | | | | | | | | | |
| (30%) | | | | | | | | | | | | | | | | |
| K\ddot{os}trosol 1540 | 15 | | | | | | 2.50 | 5.00 | | | | | | | | |
| (40%) | | | | | | | | | | | | | | | | |
| SMR 9-19-012 | 300 | | | | | | | | 4.00 | 8.00 | | | | | | |
| (25%) | | | | | | | | | | | | | | | | |
| Aerosil MOX 170 | 193 | | | | | | | | | | 4.00 | 8.00 | | | | |
| (25%) | | | | | | | | | | | | | | | | |
| Aerosil MOX 170 | 190 | | | | | | | | | | | | 6.67 | 13.33 | | |
| (15%) | | | | | | | | | | | | | | | | |
| Aerosil MOX 80 | 249 | | | | | | | | | | | | | | 4.21 | 8.42 |
| (23.74%) | | | | | | | | | | | | | | | | |

Köstrosol are silica sols from Chemiewerke Bad Köstritz. SMR 9-19-012 is a cationically stabilised silica gel from Grace. Aerosil MOX 80 and Aerosil MOX 170 are pyrogenic mixed oxides from Degussa AG.

The ink is divided into two parts, the first part being directly measured and the second part being dispersed for thirty seconds by ultrasound and then measured.

SMR 9-19-012 produced a flocculation of the ink in comparison Examples 8 and 9 and was therefore not investigated further.

The viscosity of the inks is measured with a Physica Rheometer UDS 200 on the basis of the controlled shear rate (CSR) test at a shear rate of 1000 s⁻¹ (Table 2).

The particle size distribution of the carbon black suspensions is measured according to the principle of dynamic light scattering.

The measurements are carried out with a Horiba LB-500 instrument. The frequency spectrum of the back-scattered light is analysed, whereby the suspensions can as a rule be measured in their original concentration, i.e. without dilution or similar sample preparation. The measurement range is 3 nm-6 μm.

The measurement signal is recorded over 120 sec. The evaluation is made as a surface distribution. For the calculation, which is carried out with the standard iteration number 50 (Calc.Level), the refractive index of carbon black with 1.8-10i is used. The mean particle size is determined from the surface distribution.

TABLE 2

| | | Viscosity at Room Temperature |
|---|---|---|
| | | [mPa · s] |
| Comparison | | |
| Example | | |
| 1 | dispersed | 2.76 |
| | not dispersed | 2.76 |
| 2 | dispersed | 2.70 |
| | not dispersed | 2.78 |
| 3 | dispersed | 2.86 |
| | not dispersed | 2.89 |
| 4 | dispersed | 2.72 |
| | not dispersed | 2.76 |
| 5 | dispersed | 2.69 |
| | not dispersed | 2.76 |
| 6 | dispersed | 2.61 |
| | not dispersed | 2.92 |
| 7 | dispersed | 2.69 |
| | not dispersed | 2.76 |
| Example | | |
| 1 | dispersed | 2.82 |
| | not dispersed | 2.83 |
| 2 | dispersed | 3.04 |
| | not dispersed | 3.22 |
| 3 | dispersed | 2.81 |
| | not dispersed | 3.05 |
| 4 | dispersed | 3.20 |
| | not dispersed | 3.34 |
| 5 | dispersed | 2.88 |
| | not dispersed | 2.98 |
| 6 | dispersed | 3.11 |
| | not dispersed | 3.22 |

The dispersion of the inks leads to a decrease in the viscosity.

Using the K Control Coater coating device from Erichsen Testing Equipment coatings are made with the formulated ink samples on Kompass Copy Office paper in a layer thickness of 6 μm and are stored overnight at room temperature for the further investigations.

The results of the optical density measurements made with a densitometer are shown in Table 3.

TABLE 3

| | | Optical Density |
|---|---|---|
| Comparison | | |
| example | | |
| 1 | dispersed | 1.08 |
| | not dispersed | 1.08 |
| 2 | dispersed | 1.08 |
| | not dispersed | 1.10 |
| 3 | dispersed | 1.13 |
| | not dispersed | 1.13 |
| 4 | dispersed | 1.11 |
| | not dispersed | 1.12 |
| 5 | dispersed | 1.10 |
| | not dispersed | 1.12 |
| 6 | dispersed | 1.12 |
| | not dispersed | 1.14 |
| 7 | dispersed | 1.16 |
| | not dispersed | 1.18 |
| Example | | |
| 1 | dispersed | 1.10 |
| | not dispersed | 1.14 |
| 2 | dispersed | 1.19 |
| | not dispersed | 1.22 |
| 3 | dispersed | 1.18 |
| | not dispersed | 1.20 |
| 4 | dispersed | 1.24 |
| | not dispersed | 1.29 |
| 5 | dispersed | 1.18 |
| | not dispersed | 1.15 |
| 6 | dispersed | 1.22 |
| | not dispersed | 1.23 |

The inks according to the invention, in particular Example 4, have a higher optical density compared to the comparison examples. The dispersion generally has a negative effect on the optical density.

### EXAMPLES 7-26

The inkjet inks are prepared as follows:

A 5% formulation is used as ink formulation. The carbon black dispersion consists of 15 wt. % colour black FW 18, 8 wt. % of non-ionic wetting agent mixture (6 wt. % Lutensol AO 30, 2 wt. % Hypermer CG 6), 0.2 wt. % AMP 90 and 76.8% water.

Lutensol AO 30 is a non-ionic wetting agent (manufacturer: BASF).

Hypermer CG 6 is a non-ionic wetting agent consisting of crosslinked polyoxyethylene acrylic acid (manufacturer: ICI).

Triethylene glycol and water are premixed using a magnetic stirring rod and the carbon black dispersion is added while stirring. The compound from the group comprising pyrogenic silicic acid, hydrophobised pyrogenic silicic acid, mixed oxides or pyrogenic aluminium oxide is then stirred in using a spatula and dispersed for one minute by ultrasound (Table 4).

TABLE 4

| | Comparison | | | | | | | | | | |
|---|---|---|---|---|---|---|---|---|---|---|---|
| Formulation | Example | Example | | | | | | | | | |
| (wt. %) | 10 | 7 | 8 | 9 | 10 | 11 | 12 | 13 | 14 | 15 | 16 |
| Carbon black | 33.3 | 33.3 | 33.3 | 33.3 | 33.3 | 33.3 | 33.3 | 33.3 | 33.3 | 33.3 | 33.3 |
| dispersion | | | | | | | | | | | |
| Triethylene | 15 | 15 | 15 | 15 | 15 | 15 | 15 | 15 | 15 | 15 | 15 |
| glycol | | | | | | | | | | | |
| Distilled | 51.7 | 51.2 | 50.7 | 49.7 | 48.7 | 51.2 | 50.7 | 49.7 | 48.7 | 51.2 | 50.7 |
| water | | | | | | | | | | | |
| Aerosil 200 | | 0.5 | 1.0 | 2.0 | 3.0 | | | | | | |
| Aerosil R | | | | | | 0.5 | 1.0 | 2.0 | 3.0 | | |
| 972 | | | | | | | | | | | |
| Aerosil R | | | | | | | | | | 0.5 | 1.0 |
| 8200 | | | | | | | | | | | |
| Aerosil R | | | | | | | | | | | |
| 202 | | | | | | | | | | | |
| Aerosil 300 | | | | | | | | | | | |
| Aerosil 90 | | | | | | | | | | | |
| Aerosil OX | | | | | | | | | | | |
| 50 | | | | | | | | | | | |
| Aluminium | | | | | | | | | | | |
| oxide C | | | | | | | | | | | |

| Formulation | Example | | | | | | | | | |
|---|---|---|---|---|---|---|---|---|---|---|
| (wt. %) | 17 | 18 | 19 | 20 | 21 | 22 | 23 | 24 | 25 | 26 |
| Carbon black | 33.3 | 33.3 | 33.3 | 33.3 | 33.3 | 33.3 | 33.3 | 33.3 | 33.3 | 33.3 |
| dispersion | | | | | | | | | | |
| Triethylene glycol | 15 | 15 | 15 | 15 | 15 | 15 | 15 | 15 | 15 | 15 |
| Distilled water | 49.7 | 48.7 | 50.7 | 49.2 | 49.2 | 47.7 | 49.7 | 49.7 | 49.7 | 48.7 |
| Aerosil 200 | | | | 2.0 | 2.0 | 2.0 | | | | |
| Aerosil R 972 | | | | 0.5 | | | | | | |
| Aerosil R 8200 | 2.0 | 3.0 | | | 0.5 | 2.0 | | | | |
| Aerosil R 202 | | | 1.0 | | | | | | | |
| Aerosil 300 | | | | | | | 2.0 | | | |
| Aerosil 90 | | | | | | | | 2.0 | | |
| Aerosil OX 50 | | | | | | | | | 2.0 | |
| Aluminium oxide C | | | | | | | | | | 3.0 |

Aerosil 90, Aerosil 200, Aerosil 300 and Aerosil OX 50 are hydrophilic, highly dispersed pyrogenic silicic acids from Degussa AG. Aerosil R 972, Aerosil 8200 and Aerosil R 202 are hydrophobic, pyrogenic silicic acids from Degussa AG. Aluminium oxide C is a pyrogenic aluminium oxide from Degussa AG.

Using the K Control Coater coating device from Erichsen Testing Equipment coatings are made with the formulated ink samples on HP inkjet paper and Xerox copier paper in a layer thickness of 6 μm and are stored overnight at room temperature for the further investigations.

The results of the optical density measurements made with a densitometer are shown in Table 5.

TABLE 5

Optical Density

| | Xerox Copier Paper | HP Inkjet Paper |
|---|---|---|
| Comparison | 1.14 | 1.51 |
| example 10 | | |
| Example | | |
| 7 | 1.28 | 1.59 |
| 8 | 1.32 | 1.65 |
| 9 | 1.56 | 1.78 |
| 10 | 1.64 | 1.83 |
| 11 | 1.20 | 1.50 |
| 12 | 1.21 | 1.52 |
| 13 | 1.36 | 1.60 |
| 14 | 1.39 | 1.66 |
| 15 | 1.21 | 1.51 |
| 16 | 1.16 | 1.52 |
| 17 | 1.32 | 1.51 |
| 18 | 1.37 | 1.56 |
| 19 | 1.26 | 1.56 |
| 20 | 1.52 | 1.72 |
| 21 | 1.56 | 1.71 |
| 22 | 1.51 | 1.70 |
| 23 | 1.51 | 1.70 |
| 24 | 1.34 | 1.57 |
| 25 | 1.24 | 1.52 |
| 26 | 1.58 | 1.69 |

The inks according to the invention, in particular of Examples 9, 10, 20-23 have a high optical density compared with the comparison example.

To determine the water resistance a droplet of water is dropped onto the ink coating. After 15 secs, 30 secs, 45 secs and 60 secs the droplet penetration in the paper is determined visually in each case according to the following grading: none (score 0) to marked (score 4) water penetration in the ink coating. The results are shown in Table 6.

TABLE 6

| | Water Resistance | | | | | | | |
|---|---|---|---|---|---|---|---|---|
| | Xerox Copier Paper | | | | HP Inkjet Paper | | | |
| | 15s | 30s | 45s | 60s | 15s | 30s | 45s | 60s |
| Comparison example 10 | 1 | 2 | 2− | 3+ | 2− | 2− | 2− | 2− |
| Example | | | | | | | | |
| 7 | 1 | 2− | 2− | 3+ | 2− | 3+ | 3 | 3− |
| 8 | 1 | 2− | 2− | 3+ | 2− | 3+ | 3 | 3− |
| 9 | 1− | 3+ | 3 | 3 | 2− | 3 | 3− | 4+ |
| 10 | 2 | 3 | 3− | 3− | 3 | 3 | 3− | 4+ |
| 11 | 1 | 1− | 2+ | 2 | 1 | 1− | 2 | 2− |
| 12 | 1 | 1− | 2+ | 2 | 1 | 1− | 2 | 2− |
| 13 | 1 | 1− | 2+ | 2+ | 1 | 1− | 2 | 2− |
| 14 | 1 | 1− | 2+ | 2+ | 1 | 1− | 2 | 2− |
| 15 | 0 | 1 | 1 | 2+ | 0 | 1 | 1 | 2 |
| 16 | 0 | 1 | 1 | 2+ | 0 | 1+ | 1 | 1 |
| 17 | 0 | 0 | 0 | 0 | 0 | 0 | 1 | 1 |
| 18 | 0 | 0 | 0 | 0 | 0 | 0 | 0 | 1+ |
| 19 | 0 | 1+ | 1 | 1 | 0 | 1 | 1− | 2 |
| 20 | 2 | 3 | 3− | 3− | 2 | 2− | 3+ | 3 |
| 21 | 2 | 2− | 3 | 3 | 1− | 2 | 2 | 2− |
| 22 | 1 | 1− | 1− | 1− | 0 | 1 | 2 | 2− |
| 23 | 1− | 3+ | 3− | 3− | 2− | 3 | 3− | 4+ |
| 24 | 1 | 1− | 2− | 2− | 1 | 1− | 2− | 2− |
| 25 | 1 | 1− | 2− | 2− | 1 | 2 | 2 | 2− |
| 26 | 1 | 2 | 2 | 2 | 3 | 3− | 3− | 4+ |

Examples 17 and 18 have a significantly better water resistance than the comparison example.

The colour black FW 18 is a gas black from Degussa AG having a mean primary particle size of 15 nm.

1. Inkjet ink, characterised in that it contains at least one pigment and at least one compound having a mean particle size of greater than 50 nm from the group comprising pyrogenic silicic acid, hydrophobised pyrogenic silicic acid, pyrogenic mixed oxides or pyrogenic aluminium oxides.

2. Inkjet ink according to claim 1, characterised in that the pH value is less than 9.

3. Process for the production of the inkjet ink according to claims 1 and 2, characterised in that at least one pigment is dispersed in water, optionally with the addition of wetting agent, and the pigment dispersion is mixed with a compound having a mean particle size greater than 50 nm from the group comprising pyrogenic silicic acid, hydrophobised pyrogenic silicic acid, pyrogenic mixed oxides or pyrogenic aluminium oxides.

4. Use of the inkjet ink according to claim 1 for printing paper or sheets with an inkjet printer.
